(19) United States
(12) Patent Application Publication
(10) Pub. No.: US 2023/0299623 A1
(43) Pub. Date: Sep. 21, 2023

(54) STATOR, MOTOR, COMPRESSOR, AND AIR CONDITIONER

(71) Applicant: Mitsubishi Electric Corporation, Tokyo (JP)

(72) Inventors: Hiroki IWATA, Tokyo (JP); Atsushi MATSUOKA, Tokyo (JP)

(21) Appl. No.: 18/042,905

(22) PCT Filed: Sep. 11, 2020
(86) PCT No.: PCT/JP2020/034474

§ 371 Date: Feb. 24, 2023

(51) Int. Cl. H02K 1/16

(52) U.S. Cl. CPC H02K 1/165; H02K 2213/03

(57) ABSTRACT

A stator includes a stator core having an inner circumference and an outer circumference each of which is annular, and slots which open to the inner circumference, and a coil wound on the stator core in distributed winding. The coil has an inner circumferential side coil disposed on an inner circumference side in the slot and an outer circumferential side coil disposed on an outer circumference side in the slot. The inner circumferential side coil and the outer circumferential side coil are of the same phase and connected in parallel. A resistance of the inner circumferential side coil is smaller than a resistance of the outer circumferential side coil.

### CROSS-REFERENCE TO RELATED APPLICATION

This application is a U.S. National Stage Application of International Application No. PCT/JP2020/034474 filed on Sep. 11, 2020, the contents of which are incorporated herein by reference.

### TECHNICAL FIELD

The present disclosure relates to a stator, a motor, a compressor, and an air conditioner.

### BACKGROUND

As a winding type of coils in a stator of a motor, distributed winding is well-known. In a distributed winding stator, there is a case where one coil is arranged on the inner circumference side of a slot of a stator core, and another coil is arranged on the outer circumference side of the same slot. In this case, non-uniformity of impedance occurs between the inner circumferential side coil and the outer circumferential side coil, which causes copper loss.

In Patent Reference 1, it is proposed to wind coils of respective phases on a stator core so that coil ends of the coils intersect each other, in order to make impedance uniform.

### PATENT REFERENCE

Patent Reference 1: Japanese Patent Application Publication No. 2012-152005 (see FIG. 5)

However, the method of winding coils so that the coil ends intersect each other as described above makes the winding operation complicated.

### SUMMARY

The present disclosure is intended to solve the above problem, and an object of the present disclosure is to reduce copper loss due to non-uniform impedance of coils without complicating the winding operation.

A stator of the present disclosure includes a stator core having an inner circumference and an outer circumference each of which is annular, and a slot which opens to the inner circumference, and a coil wound on the stator core in distributed winding. The coil has an inner circumferential side coil disposed on an inner circumference side in the slot and an outer circumferential side coil disposed on an outer circumference side in the slot. The inner circumferential side coil and the outer circumferential side coil are of the same phase and connected in parallel. A resistance of the inner circumferential side coil is smaller than a resistance of the outer circumferential side coil.

In the present disclosure, since the resistance of the inner circumferential side coil is smaller than the resistance of the outer circumferential side coil, the resistance ratio between these coils can be made closer to the inductance ratio between these coils. Thus, the non-uniformity of impedance can be reduced, and copper loss can be reduced. Further, the coil ends of the inner circumferential side coil and the outer circumferential side coil do not need to be intersected, and thus the winding operation is not complicated.

### BRIEF DESCRIPTION OF THE DRAWINGS

FIG. 1 is a cross-sectional view illustrating a motor of a first embodiment.

FIG. 2 is a cross-sectional view illustrating a stator of the first embodiment.

FIG. 3 is a plan view illustrating a stator core of the first embodiment.

FIG. 4 is a schematic diagram illustrating the stator core and a U-phase coil of the first embodiment.

FIG. 5 is a plan view illustrating an arrangement of coils of respective phases in the first embodiment.

FIG. 6 is an equivalent circuit diagram of the motor of the first embodiment.

FIG. 7 is an equivalent circuit diagram of the U-phase coil of the first embodiment.

FIG. 8 is a diagram for explaining a phase difference between an outer circumferential side coil and an inner circumferential side coil of the first embodiment.

FIG. 9 is a graph showing the relationship between the resistance ratio of the outer circumferential side coil to the inner circumferential side coil and the ratio of an internal copper loss to the total copper loss of the coil in the first embodiment.

FIG. 10 is a graph showing the relationship between the resistance ratio of the outer circumferential side coil to the inner circumferential side coil and the ratio of an internal copper loss to the total copper loss of the coil in the first embodiment.

FIG. 11 is a schematic diagram illustrating an inner circumferential side coil of a U-phase coil of a second embodiment.

FIG. 12(A) is a schematic diagram illustrating a wire of the inner circumferential side coil of the U-phase coil, and

FIG. 12(B) is a schematic diagram illustrating a wire of an outer circumferential side coil of the U-phase coil in the second embodiment.

FIG. 13 is a perspective view illustrating a winding frame for the inner circumferential side coil of the U-phase coil of the second embodiment.

FIG. 14(A) is a diagram illustrating a winding frame for the inner circumferential side coil of the U-phase coil, and

FIG. 14(B) is a diagram illustrating a winding frame for an outer circumferential side coil of the U-phase coil in the second embodiment.

FIG. 15(A) is a diagram illustrating an inner circumferential side coil and its cross-section of a U-phase coil, and FIG. 15(B) is a diagram illustrating an outer circumferential side coil and its cross-section of the U-phase coil in a third embodiment.

FIG. 16(A) is a diagram illustrating an inner circumferential side coil and its cross-section of a U-phase coil, and FIG. 16(B) is a diagram illustrating an outer circumferential side coil and its cross-section of the U-phase coil in a fourth embodiment.

FIG. 17 is a perspective view illustrating a stator core and a U-phase coil of a fifth embodiment.

FIG. 18 is a longitudinal cross-sectional view illustrating a compressor to which the motor of any of the first to fifth embodiments is applicable.

FIG. 19 is a diagram illustrating an air conditioner that includes the compressor illustrated in FIG. 18.

### DETAILED DESCRIPTION

### First Embodiment

### Configuration of Motor

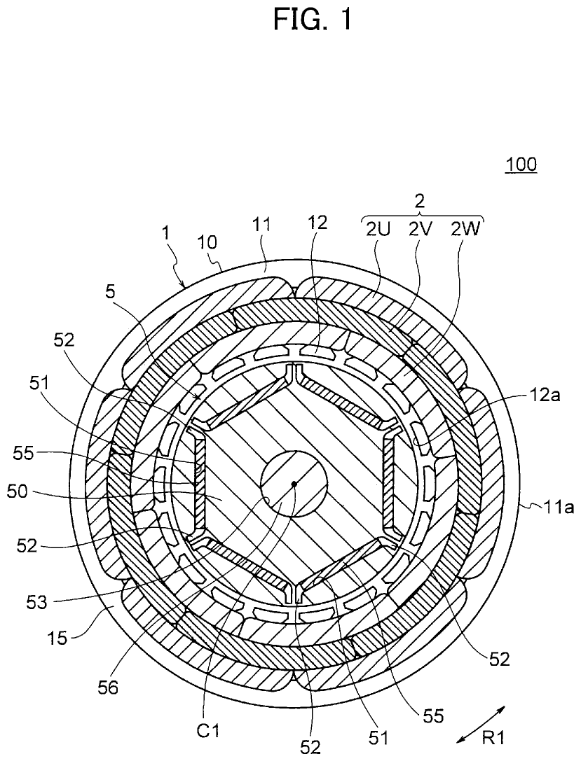

FIG. 1 is a cross-sectional view illustrating a motor 100 of a first embodiment. The motor 100 is a synchronous motor. The motor 100 includes a stator 1 and a rotor 5 rotatably provided inside the stator 1. An air gap is provided between the stator 1 and the rotor 5.

The rotor 5 has a cylindrical rotor core 50 and permanent magnets 55 attached to the rotor core 50. The rotor core 50 is formed of electromagnetic steel sheets, each having a sheet thickness of, for example, 0.1 to 0.7 mm, which are integrally fixed together by crimping or the like.

The rotor core 50 has a circular shaft hole 53 formed at its center in the radial direction. A shaft 56, which is a rotary shaft, is fixed to the shaft hole 53 by press-fitting. An axis C1, which is a central axis of the shaft 56, serves as a rotation axis of the rotor 5.

Hereinafter, the direction of the axis C1 of the shaft 56 is referred to as an “axial direction”. The circumferential direction about the axis C1 (indicated by the arrow R1 in FIG. 1 and other figures) is referred to as a “circumferential direction”. The radial direction about the axis C1 is referred to as a “radial direction”.

A plurality of magnet insertion holes 51 are formed at equal intervals in the circumferential direction along the outer circumference of the rotor core 50. The number of magnet insertion holes 51 is six in this example. Each magnet insertion hole 51 penetrates the rotor core 50 in the axial direction.

The permanent magnet 55 is disposed inside the magnet insertion hole 51. The permanent magnet 55 is a flat plate-shaped member and has a rectangular cross-sectional shape in a plane perpendicular to the axial direction. The permanent magnet 55 has a width in the circumferential direction and a thickness in the radial direction. One permanent magnet 55 is disposed in each magnet insertion hole 51. In this regard, a plurality of permanent magnets 55 may be disposed in each magnet insertion hole 51.

The number of poles of the rotor 5 corresponds to the number of magnet insertion holes 51 and is six in this example. In this regard, the number of poles of the rotor 5 is not limited to six, but may be two or more. The magnet insertion hole 51 extends linearly in a direction orthogonal to a straight line (magnetic pole center line) in the radial direction passing through the pole center. Incidentally, the magnet insertion hole is not limited to such a shape, but may extend in a V shape, for example.

The permanent magnet 55 is made of a rare earth sintered magnet that contains neodymium (Nd), iron (Fe) and boron (B). In this regard, the permanent magnet 55 is not limited to the rare earth magnet and may be, for example, a ferrite magnet. Adjacent permanent magnets 55 have their opposite magnetic poles facing the outer circumferential side.

A flux barrier 52, which is a cavity, is formed on each of both ends of the magnet insertion hole 51 in the circumferential direction. A thin wall portion is formed between the flux barrier 52 and an outer circumference of the rotor core 50. In order to suppress leakage magnetic flux between adjacent magnetic poles, the thin wall portion is formed to have, for example, a width equal to the sheet thickness of the electromagnetic steel sheet.

### Configuration of Stator

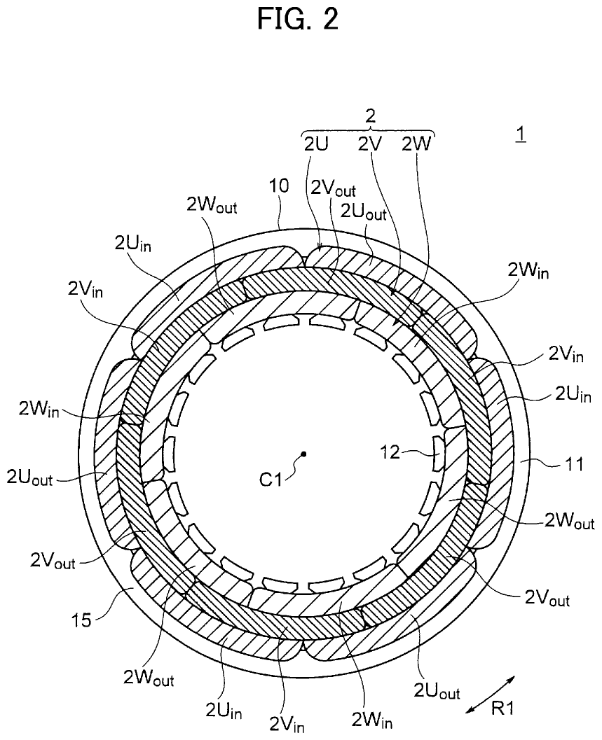

FIG. 2 is a cross-sectional view illustrating the stator 1. The stator 1 has a stator core 10 and coils 2 wound on the stator core 10 in distributed winding. The stator core 10 is formed of electromagnetic steel sheets, each having a sheet thickness of, for example, 0.1 to 0.7 mm, which are integrally fixed together by crimping or the like.

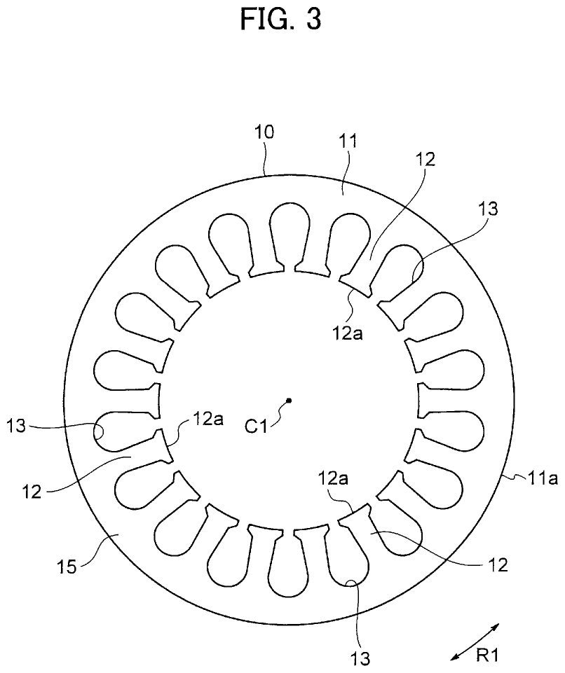

FIG. 3 is a plan view illustrating the stator core 10. The stator core 10 has an annular yoke 11 and a plurality of teeth 12 extending inward in the radial direction from the yoke 11. In an example illustrated in FIG. 3, the number of teeth 12 is 18. The tooth 12 has a tip end 12a on its inner side in the radial direction, and the tip end 12a faces the rotor 5 (FIG. 1). The tip end 12a of the tooth 12 has an arc shape.

A slot 13 is formed between teeth 12 adjacent to each other in the circumferential direction. The slot 13 is a portion in which the coil 2 wound around the tooth 12 is housed. The number of slots 13 is the same as the number of teeth 12, and is 18 in this example. A not-shown insulating portion is provided between the slot 13 and the coil 2.

An outer circumference 11a of the yoke 11 has a circular annular shape about the axis C1, and corresponds to the outer circumference of the stator core 10. The tip ends 12a of the teeth 12 are formed on a circular ring about the axis C1 and correspond to the inner circumference of the stator core 10. Thus, it can be said that the slot 13 opens to the inner circumference of the stator core 10.

With reference to FIG. 2 again, the coils 2 wound on the stator core 10 include a U-phase coil 2U as a first-phase coil, a V-phase coil 2V as a second-phase coil, and a W-phase coil 2W as a third-phase coil.

The U-phase coil 2U, the V-phase coil 2V and the W-phase coil 2W are located at different positions in the radial direction. In this example, the U-phase coil 2U is located on the outermost side in the radial direction, the W-phase coil 2W is located on the innermost side in the radial direction, and the V-phase coil 2V is located between the U-phase coil 2U and the W-phase coil 2W.

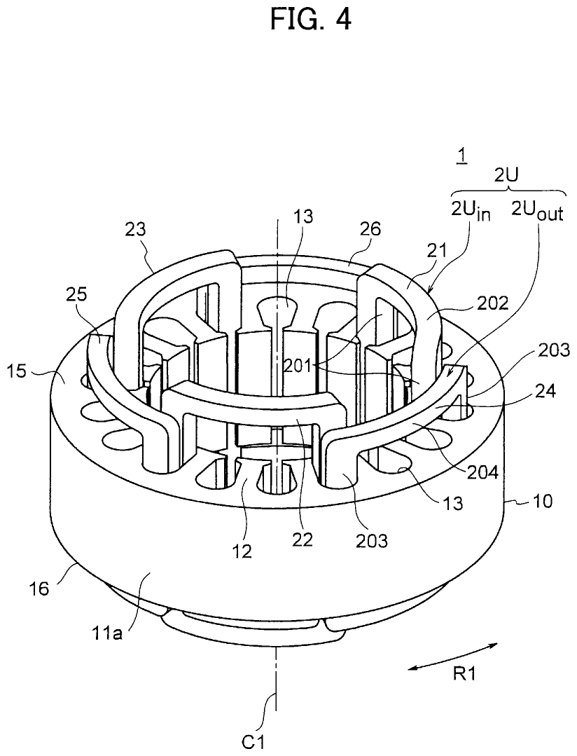

FIG. 4 is a schematic diagram illustrating the U-phase coil 2U and the stator core 10. The U-phase coil 2U has an inner circumferential side coil 2Uᵢₙ and an outer circumferential side coil 2Uₒᵤₜ, which are connected in parallel. The inner circumferential side coil 2Uᵢₙ is located on the inner side in the radial direction, while the outer circumferential side coil 2Uₒᵤₜ is located on the outer side in the radial direction.

The inner circumferential side coil 2Uᵢₙ of the U-phase coil 2U is wound at a three-slot pitch. Being wound at a three-slot pitch means being wound every three slots, in other words, being wound so as to span three teeth 12.

A part of the inner circumferential side coil 2Uᵢₙ that is wound at the three-slot pitch is referred to as a winding portion. The inner circumferential side coil 2Uᵢₙ has three winding portions 21, 22, and 23. Each of the winding portions 21, 22, and 23 has slot insertion portions 201 that are inserted into the slots 13 and coil ends 202 extending along end surfaces 15 and 16 of the stator core 10.

The outer circumferential side coil 2Uₒᵤₜ of the U-phase coil 2U is wound at the three-slot pitch. The outer circumferential side coil 2Uₒᵤₜ has three winding portions 24, 25, and 26. Each of the winding portions 24, 25, and 26 has slot insertion portions 203 that are inserted into the slot 13 and coil ends 204 extending along end surfaces 15 and 16 of the stator core 10.

The winding portions 21, 22, and 23 of the inner circumferential side coil 2Uᵢₙ and the winding portions 24, 25, and 26 of the outer circumferential side coil 2Uₒᵤₜ are alternately arranged in the circumferential direction.

The slot insertion portion 201 of the inner circumferential side coil 2Uᵢₙ and the slot insertion portion 203 of the outer circumferential side coil 2Uₒᵤₜ that is adjacent to the inner circumferential side coil 2Uᵢₙ are housed in the same slot 13.

Within the slot 13, the slot insertion portion 203 of the outer circumferential side coil 2Uₒᵤₜ is disposed on the outer side in the radial direction (i.e., in an outer layer), while the slot insertion portion 201 of the inner circumferential side coil 2Uᵢₙ is disposed on the inner side in the radial direction (i.e., in an inner layer).

In this example, the winding portions 21, 22, and 23 are connected in series, and the winding portions 24, 25, and 26 are also connected in series. However, these winding portions are not limited to such an arrangement. The winding portions 21, 22, and 23 may be connected in parallel. The winding portions 24, 25, and 26 may be connected in parallel.

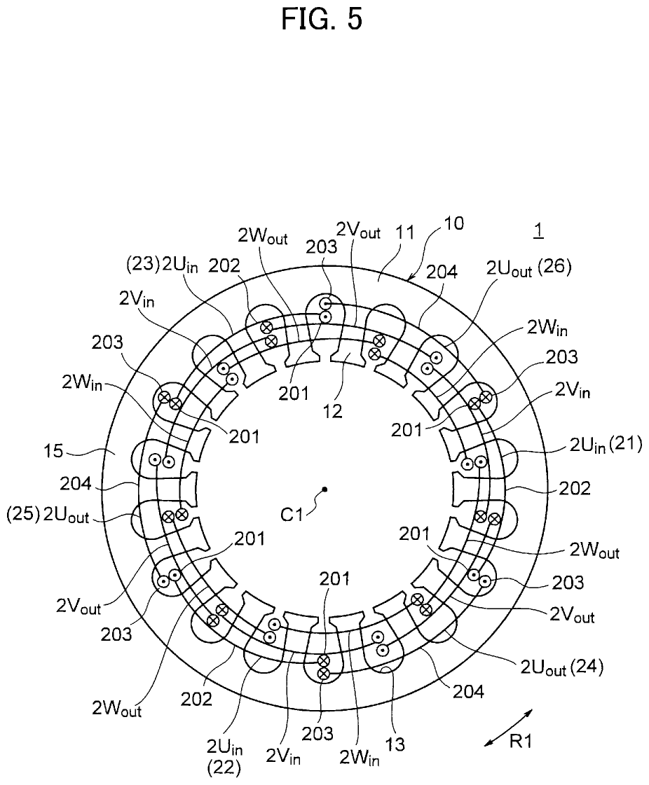

FIG. 5 is a schematic view illustrating the arrangement of the U-phase coil 2U, the V-phase coil 2V, and the W-phase coil 2W in the stator core 10. The arrangement of the U-phase coil 2U is as described with reference to FIG. 4.

The V-phase coil 2V has an inner circumferential side coil 2Vᵢₙ and an outer circumferential side coil 2Vₒᵤₜ, which are connected in parallel. The inner circumferential side coil 2Vᵢₙ is located on the inner side in the radial direction, while the outer circumferential side coil 2Vₒᵤₜ is located on the outer side in the radial direction. In this regard, the outer circumferential side coil 2Vₒᵤₜ is located on the inner side in the radial direction with respect to the inner circumferential side coil 2Uᵢₙ of the U-phase.

Each of the inner circumferential side coil 2Vᵢₙ and the outer circumferential side coil 2Vₒᵤₜ is wound at the three-slot pitch. Each of the inner circumferential side coil 2Vᵢₙ and the outer circumferential side coil 2Vₒᵤₜ has three winding portions, as with the inner circumferential side coil 2Uᵢₙ and the outer circumferential side coil 2Uₒᵤₜ of the U-phase.

The slot insertion portion of the inner circumferential side coil 2Vᵢₙ is inserted in the slot 13 adjacent in the circumferential direction (in this example, counterclockwise) to the slot 13 into which the slot insertion portion 201 of the inner circumferential side coil 2Uᵢₙ of the U-phase is inserted.

The slot insertion portion of the outer circumferential side coil 2Vₒᵤₜ is housed in the same slot 13 as the slot insertion portion of the inner circumferential side coil 2Vᵢₙ adjacent to this outer circumferential side coil 2Vₒᵤₜ. The slot insertion portion of the outer circumferential side coil 2Vₒᵤₜ is disposed in an outer layer in the slot 13, while the slot insertion portion of the inner circumferential side coil 2Vᵢₙ is disposed in an inner layer in the slot 13.

The W-phase coil 2W has an inner circumferential side coil 2Wᵢₙ and an outer circumferential side coil 2Wₒᵤₜ, which are connected in parallel. The inner circumferential side coil 2Wᵢₙ is located on the inner side in the radial direction, while the outer circumferential side coil 2Wₒᵤₜ is located on the outer side in the radial direction. In this regard, the outer circumferential side coil 2Wₒᵤₜ is located on the inner side in the radial direction with respect to the inner circumferential side coil 2Vᵢₙ of the V-phase.

Each of the inner circumferential side coil 2Wᵢₙ and the outer circumferential side coil 2Wₒᵤₜ is wound at the three-slot pitch. Each of the inner circumferential side coil 2Wᵢₙ and the outer circumferential side coil 2Wₒᵤₜ has three winding portions, as with the inner circumferential side coil 2Uᵢₙ and the outer circumferential side coil 2Uₒᵤₜ of the U-phase.

The slot insertion portion of the inner circumferential side coil 2Wᵢₙ is inserted in the slot 13 adjacent in the circumferential direction (in this example, counterclockwise) to the slot 13 into which the slot insertion portion of the inner circumferential side coil 2Vᵢₙ of the V-phase is inserted.

The slot insertion portion of the outer circumferential side coil 2Wₒᵤₜ is housed in the same slot 13 as the slot insertion portion of the inner circumferential side coil 2Wᵢₙ adjacent to this outer circumferential side coil 2Wₒᵤₜ. The slot insertion portion of the outer circumferential side coil 2Wₒᵤₜ is disposed in an outer layer in the slot 13, while the slot insertion portion of the inner circumferential side coil 2Wᵢₙ is disposed in an inner layer in the slot 13.

In a winding step of the coils 2, the outer circumferential side coil 2Uₒᵤₜ of the U-phase, the inner circumferential side coil 2Uᵢₙ of the U-phase, the outer circumferential side coil 2Vₒᵤₜ of the V-phase, the inner circumferential side coil 2Vᵢₙ of the V-phase, the outer circumferential side coil 2Wₒᵤₜ of the W-phase, and the inner circumferential side coil 2Wᵢₙ of the W-phase are inserted in this order into the slots 13 by using an inserter. Thus, the winding operation is simplified.

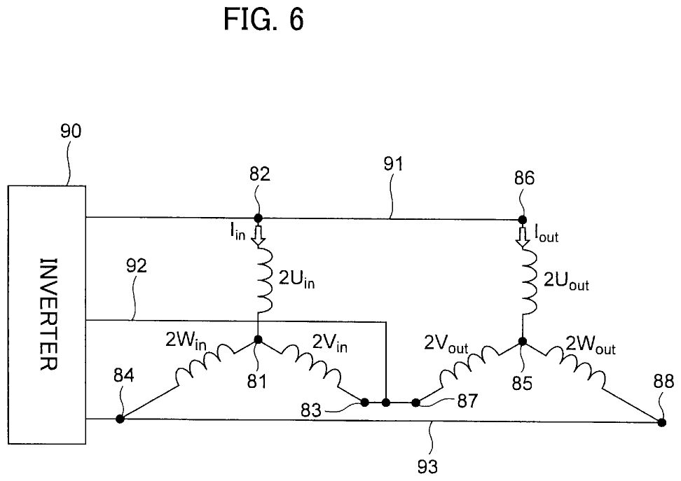

FIG. 6 is an equivalent circuit diagram of the motor 100. The U-phase coil 2U, the V-phase coil 2V, and the W-phase coil 2W are controlled by an inverter 90. The inner circumferential side coils 2Uᵢₙ, 2Vᵢₙ, and 2Wᵢₙ are connected in Y-connection, while the outer circumferential side coils 2Uₒᵤₜ, 2Vₒᵤₜ, and 2Wₒᵤₜ are connected in Y-connection. Two Y-connection parts are connected in parallel.

More specifically, first terminals of the inner circumferential side coils 2Uᵢₙ, 2Vᵢₙ, and 2Wᵢₙ are connected to a neutral point 81. A second terminal 82 of the inner circumferential side coil 2Uᵢₙ is connected to a wiring 91, a second terminal 83 of the inner circumferential side coil 2Vᵢₙ is connected to a wiring 92, and a second terminal 84 of the inner circumferential side coil 2Wᵢₙ is connected to a wiring 93.

First terminals of the outer circumferential side coils 2Uₒᵤₜ, 2Vₒᵤₜ, and 2Wₒᵤₜ are connected to a neutral point 85. A second terminal 86 of the outer circumferential side coil is connected to the wiring 91, a second terminal 87 of the outer circumferential side coil 2Vₒᵤₜ is connected to the wiring 92, and a second terminal 88 of the outer circumferential side coil 2Wₒᵤₜ is connected to the wiring 93.

The inner circumferential side coils 2Uᵢₙ, 2Vᵢₙ, and 2Wᵢₙ have the same impedance, and the outer circumferential side coils 2Uₒᵤₜ, 2Vₒᵤₜ, and 2Wₒᵤₜ have the same impedance. Therefore, it can be thought that both Y-connection parts are in three-phase equilibrium, and that the neutral points 81 and 85 are at the same potential.

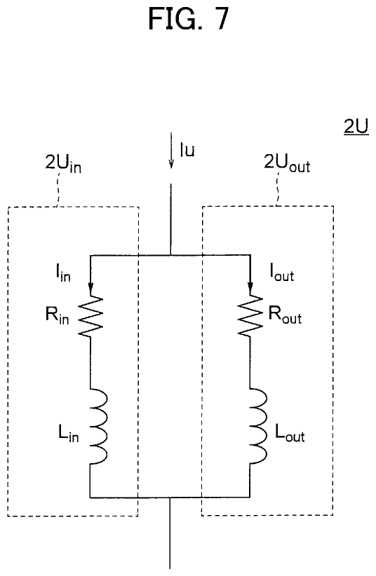

For this reason, each of the coils 2U, 2V, and 2W of the respective phases can be considered as a simple parallel circuit. FIG. 7 is an equivalent circuit diagram of the U-phase coil 2U. The inner circumferential side coil 2Uᵢₙ and the outer circumferential side coil 2Uₒᵤₜ are connected in parallel. The resistance of the inner circumferential side coil 2Uᵢₙ is denoted by Rⁱⁿ, and the inductance of the inner circumferential side coil 2Uᵢₙ is denoted by Lᵢₙ. The resistance of the outer circumferential side coil 2Uₒᵤₜ is denoted by Rₒᵤₜ, and the inductance of the outer circumferential side coil 2Uₒᵤₜ is denoted by Lₒᵤₜ.

As described above, since the outer circumferential side coil 2Uₒᵤₜ is located on the outer side in the radial direction with respect to the inner circumferential side coil 2Uᵢₙ, the inductance Lₒᵤₜ of the outer circumferential side coil 2Uₒᵤₜ is larger than the inductance Lᵢₙ of the inner circumferential side coil 2Uᵢₙ, and the difference between the inductances (Lₒᵤₜ−Lᵢₙ) is 20% or greater. In other words, Lₒᵤₜ/Lᵢₙ is 1.2 or greater.

When such a difference exists between the inductances Lin and Lₒᵤₜ, the non-uniformity of impedance (the sum of the resistance and the inductance) occurs between the inner circumferential side coil 2Uᵢₙ and the outer circumferential side coil 2Uₒᵤₜ.

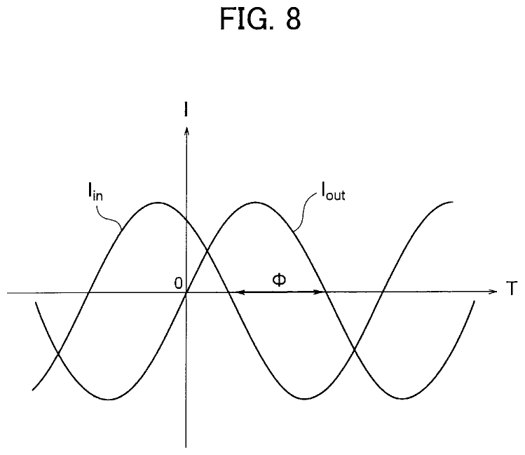

As a result, due to the non-uniform impedance, a phase difference occurs between a current Iᵢₙ flowing from the wiring 91 (FIG. 6) to the inner circumferential side coil 2Uᵢₙ and a current Iₒᵤₜ flowing from the wiring 91 to the outer circumferential side coil 2Uₒᵤₜ. FIG. 8 is a graph showing the phase difference between the current Iᵢₙ and the current Iₒᵤₜ, where the horizontal axis represents time, and the vertical axis represents the current.

The phase difference between the current Iᵢₙ and the current Iₒᵤₜ generates a circulating current and causes copper loss. In order to reduce copper loss, the phase difference needs to be suppressed so that no circulating current is generated. Thus, it is most desirable that a phase difference is zero.

Hereinafter, a description will be given of the conditions for reducing the phase difference between the current Iᵢₙ of the inner circumferential side coil and the current Iₒᵤₜ of the outer circumferential side coil. The coils 2Uᵢₙ and 2Uₒᵤₜ of the U-phase coil 2U are described herein, but the same can be applied to the coils 2Vᵢₙ and 2Vₒᵤₜ of the V-phase coil 2V and the coils 2Wᵢₙ and 2Wₒᵤₜ of the W-phase coil 2W.

The ratio Iᵢₙ/Iᵤ of the current Iᵢₙ flowing to the inner circumferential side coil 2Uᵢₙ to the composite current vector Iᵤ of the U-phase can be expressed by the following formula (1). The ratio Iₒᵤₜ/Iᵤ of the current Iₒᵤₜ flowing to the outer circumferential side coil 2Uₒᵤₜ to the composite current vector Iᵤ of the U-phase can be expressed by the following formula (2).

$$\begin{matrix}[ Formula 1 ] & \\ \frac{{I}_{in}}{{I}_{u}} = \frac{{Z}_{o u t}}{{Z}_{in} + {Z}_{o u t}} & ( 1 )\end{matrix}$$

$$\begin{matrix}[ Formula 2 ] & \\ \frac{{I}_{o u t}}{{I}_{u}} = \frac{{Z}_{í n}}{{Z}_{í n} + {Z}_{o u t}} & ( 2 )\end{matrix}$$

Rᵢₙ is a resistance of the inner circumferential side coil 2Uᵢₙ, and Rₒᵤₜ is a resistance of the outer circumferential side coil 2Uₒᵤₜ. Zᵢₙ is an impedance of the inner circumferential side coil 2Uᵢₙ and Zₒᵤₜ is an impedance of the outer circumferential side coil 2Uₒᵤₜ.

Based on the formulas (1) and (2), a phase ϕᵢₙ of the current Iᵢₙ flowing to the inner circumferential side coil 2Uᵢₙ and a phase ϕₒᵤₜ of the current Iₒᵤₜ flowing to the outer circumferential side coil 2Uₒᵤₜ with respect to the composite current vector Iᵤ are expressed by the following formulas (3) and (4).

$$\begin{matrix}[ Formula 3 ] & \\ {ϕ}_{in} = {tan}^{- 1} \frac{ω {L}_{in} {R}_{o u t} - ω {L}_{o u t} {R}_{in}}{{R}_{in} ( {R}_{in} + {R}_{o u t} ) + {ω}^{2} {L}_{in} ( {L}_{in} + {L}_{o u t} )} & ( 3 )\end{matrix}$$

$$\begin{matrix}[ Formula 4 ] & \\ {ϕ}_{o u t} = {tan}^{- 1} \frac{ω {L}_{o u t} {R}_{in} - ω {L}_{in} {R}_{o u t}}{{R}_{o u t} ( {R}_{in} + {R}_{o u t} ) + {ω}^{2} {L}_{o u t} ( {L}_{in} + {L}_{o u t} )} & ( 4 )\end{matrix}$$

Lᵢₙ is an inductance of the inner circumferential side coil 2Uᵢₙ, Lₒᵤₜ is an inductance of the outer circumferential side coil 2Uₒᵤₜ, and ω is an angular frequency.

In an ideal state where there is no difference between the impedance Zᵢₙ of the inner circumferential side coil 2Uᵢₙ and the impedance Zₒᵤₜ of the outer circumferential side coil 2Uₒᵤₜ, Lᵢₙ=Lₒᵤₜ and Rᵢₙ=Rₒᵤₜ are satisfied. In this case, ϕᵢₙ=ϕₒᵤₜ=0 is satisfied, and thus there is no phase difference between the currents Iᵢₙ and Iₒᵤₜ.

In this regard, since the inner circumferential side coil 2Uᵢₙ and the outer circumferential side coil 2Uₒᵤₜ are located at different positions in the radial direction, it is difficult to make the inductances Lᵢₙ and Lₒᵤₜ identical to each other.

Meanwhile, based on the above formulas (3) and (4), the condition in which the phase ϕᵢₙ of the current Iᵢₙ and the phase ϕₒᵤₜ of the current Iₒᵤₜ with respect to the composite current vector Iᵤ are equal to each other (ϕᵢₙ=ϕₒᵤₜ) is determined. As a result, the following formula (5) is obtained.

$$\begin{matrix}[ Formula 5 ] & \\ \frac{{L}_{o u t}}{{L}_{in}} = \frac{{R}_{o u t}}{{R}_{in}} & ( 5 )\end{matrix}$$

That is, by making the ratio Rₒᵤₜ/Rᵢₙ of the resistance of the outer circumferential side coil 2Uₒᵤₜ to the resistance of the inner circumferential side coil 2Uᵢₙ the same as the ratio Lₒᵤₜ/Lᵢₙ of the inductance, the phase ϕᵢₙ of the current Iᵢₙ and the phase ϕₒᵤₜ of the current Iₒᵤₜ with respect to the composite current vector Iᵤ can be made equal to each other.

From this, it is understood that by making the resistance ratio Rₒᵤₜ/Rᵢₙ closer to the inductance ratio Lₒᵤₜ/Lᵢₙ, the phase difference (ϕᵢₙ−ϕₒᵤₜ) between the currents Iᵢₙ and Iₒᵤₜ can be made closer to zero, and thus copper loss due to non-uniform impedance can be reduced.

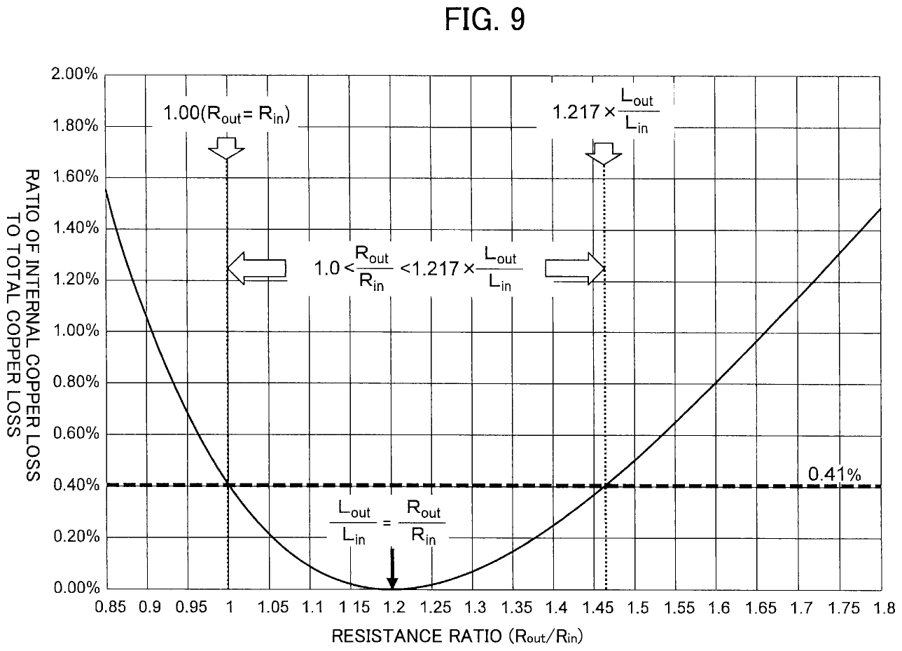

FIG. 9 is a graph showing the relationship between the resistance ratio Rₒᵤₜ/Rᵢₙ and the ratio of the internal copper loss to the total copper loss of the U-phase coil 2U. The internal copper loss refers to a copper loss caused by the currents Iᵢₙ and Iₒᵤₜ with different phases that flow through the coils 2Uᵢₙ and 2Uₒᵤₜ connected in parallel. Meanwhile, the total copper loss, including the internal copper loss, is the sum of the product of the resistance Rᵢₙ of the coil 2Uᵢₙ and the square of the current Iᵢₙ flowing through the coil 2Uᵢₙ and the product of the resistance Rₒᵤₜ of the coil 2Uₒᵤₜ and the square of the current Iₒᵤₜ flowing through the coil 2Uₒᵤₜ (Rᵢₙ×Iᵢₙ²+Rₒᵤₜ×Iₒᵤₜ2).

In a general motor, the resistance Rₒᵤₜ of the outer circumferential side coil 2Uₒᵤₜ and the resistance Rᵢₙ of the inner circumferential side coil 2Uᵢₙ are equal (i.e., Rₒᵤₜ/Rᵢₙ=1). In this case, the ratio of the internal copper loss to the total copper loss of the U-phase coil 2U (hereinafter simply referred to as the “ratio of the internal copper loss to the total copper loss”) is 0.41%.

If Rₒᵤₜ/Rᵢₙ exceeds 1.0, the ratio of the internal copper loss to the total copper loss is less than 0.41%. If Rₒᵤₜ/Rᵢₙ exceeds 1.46, the ratio of the internal copper loss to the total copper loss is greater than 0.41%.

That is, it is understood that if Rₒᵤₜ/Rᵢₙ is greater than 1.0 and less than 1.46, copper loss in the motor can be reduced as compared to a motor satisfying Rₒᵤₜ=Rᵢₙ.

In this example, as described above, a difference in the inductance (Lₒᵤₜ−Lᵢₙ) between the outer circumferential side coil 2Uₒᵤₜ and the inner circumferential side coil 2Uᵢₙ is generally greater than or equal to 20%.

When Lₒᵤₜ/Lᵢₙ is set to 1.2, the upper limit value of Rₒᵤₜ/Rᵢₙ, 1.46, can be expressed as 1.217×Lₒᵤₜ/Lᵢₙ. That is, the range of Rₒᵤₜ/Rᵢₙ, in which copper loss is reduced more than in the motor satisfying Rₒᵤₜ=Rᵢₙ, is expressed by the following formula (6).

$$\begin{matrix}[ Formula 6 ] & \\ 1.0 < \frac{{R}_{o u t}}{{R}_{i n}} < 1.217 \times \frac{{L}_{o u t}}{{L}_{i n}} & ( 6 )\end{matrix}$$

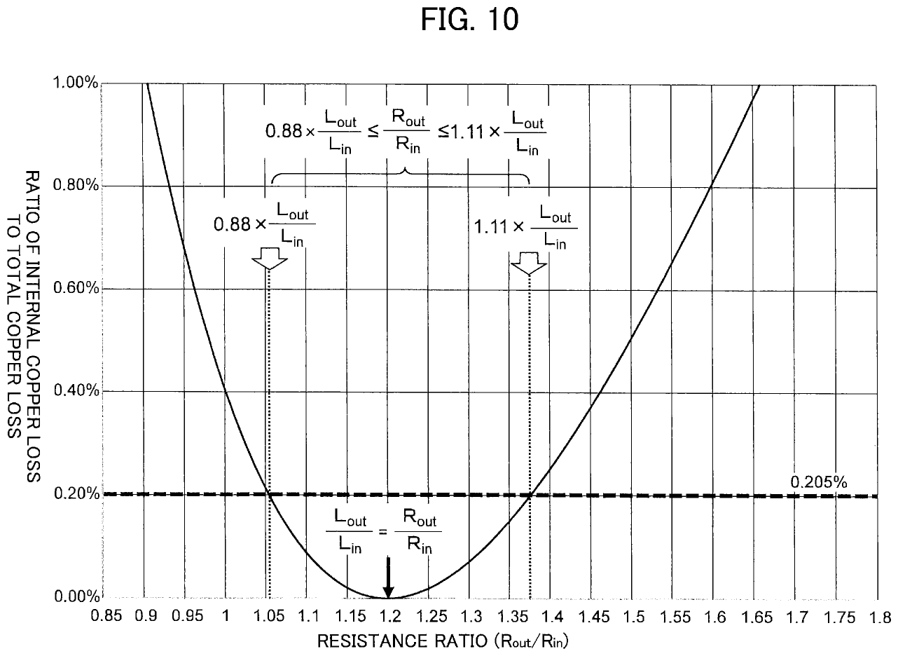

FIG. 10 is an enlarged graph showing the range of 0.00 to 1.00% in the vertical axis of FIG. 9. As described above, in the motor satisfying Rₒᵤₜ=Rᵢₙ, the ratio of the internal copper loss to the total copper loss is 0.41% (FIG. 9), and its half (½) is 0.205%.

As can be seen from FIG. 10, when the ratio Rₒᵤₜ/Rᵢₙ is within the range from 1.056 to 1.38, the ratio of the internal copper loss to the total copper loss is reduced to 0.205% or less.

When Lₒᵤₜ/Lᵢₙ is set to 1.2, the lower limit value of Rₒᵤₜ/Rᵢₙ, 1.056, can be expressed as 0.88×Lₒᵤₜ/Lᵢₙ, while the upper limit value of Rₒᵤₜ/Rᵢₙ, 1.38, can be expressed as 1.15×Lₒᵤₜ/Lᵢₙ. Thus, the range Rₒᵤₜ/Rᵢₙ, in which the ratio of the internal copper loss to the total copper loss is suppressed to 0.205% or less, can be expressed by the following formula (7).

$$\begin{matrix}[ Formula 7 ] & \\ 0.88 \times \frac{{L}_{o u t}}{{L}_{i n}} \leq \frac{{R}_{o u t}}{{R}_{i n}} \leq 1.15 \times \frac{{L}_{o u t}}{{L}_{i n}} & ( 7 )\end{matrix}$$

In FIG. 9, the ratio of the internal copper loss to the total copper loss is the smallest when Rₒᵤₜ/Rᵢₙ is 1.2. In other words, copper loss is reduced the most when the above formula (5) is satisfied.

In this way, when the resistances Rᵢₙ and Rₒᵤₜ and the inductances Lᵢₙ and Lₒᵤₜ of the coils 2Uᵢₙ and 2Uₒᵤₜ satisfy the formula (6), copper loss in the motor is reduced and the motor efficiency is improved as compared with the motor satisfying Rᵢₙ=Rₒᵤₜ In addition, when the formula (7) is satisfied, copper loss is further reduced, and the motor efficiency is further improved. Furthermore, when the formula (5) is satisfied, copper loss is reduced the most, and the motor efficiency is improved the most.

In other words, copper loss due to non-uniform impedance can be reduced and the motor efficiency can be enhanced, by setting the resistance ratio Rₒᵤₜ/Rᵢₙ to be greater than 1 to make this ratio closer to the inductance ratio Lₒᵤₜ/Lᵢₙ.

Although the U-phase coil 2U has been described herein, the same can be applied to the V-phase coil 2V and the W-phase coil 2W. That is, also as for the V-phase coil 2V and the W-phase coil 2W, copper loss can be reduced and the motor efficiency can be improved, by setting the resistance ratio Rₒᵤₜ/Rᵢₙ to be greater than 1 to make this ratio closer to the inductance ratio Lₒᵤₜ/Lᵢₙ. In particular, when the formula (5), (6), or (7) is satisfied, copper loss can be reduced and the motor efficiency can be improved.

### Effects of Embodiment

As described above, the stator 1 of the first embodiment includes the stator core 10 and the coil 2 wound on the stator core 10 in the distributed winding. The coil 2 has the inner circumferential side coil disposed in the inner layer and the outer circumferential side coil disposed in the outer layer in the same slot 13. The inner circumferential side coil and the outer circumferential side coil are of the same phase and connected in parallel. The resistance Rᵢₙ of the inner circumferential side coil is smaller than the resistance Rₒᵤₜ of the outer circumferential side coil. Thus, the resistance ratio Rₒᵤₜ/Rᵢₙ of the outer circumferential side coil to the inner circumferential side coil can be made greater than 1 and made closer to the inductance ratio Lₒᵤₜ/Lᵢₙ. Consequently, the phase difference (ϕᵢₙ−ϕₒᵤₜ) between the currents Iᵢₙ and Iₒᵤₜ can be reduced, and therefore copper loss due to non-uniform impedance can be reduced and the motor efficiency can be improved.

When the resistances Rₒᵤₜ and Rᵢₙ and the inductances Lᵢₙ and Lₒᵤₜ of the inner circumferential side coil and the outer circumferential side coil satisfy the formula (6), copper loss in the motor can be reduced and the motor efficiency can be improved as compared to the motor satisfying Rᵢₙ=Rₒᵤₜ.

When the resistances Rₒᵤₜ and Rᵢₙ and the inductances Lᵢₙ and Lₒᵤₜ of the inner circumferential side coil and the outer circumferential side coil satisfy the formula (7), copper loss can be further reduced, and the motor efficiency can be further improved.

When the resistances Rₒᵤₜ and Rᵢₙ and the inductances Lᵢₙ and Lₒᵤₜ of the inner circumferential side coil and the outer circumferential side coil satisfy the formula (5), the phase difference between the currents Iᵢₙ and Iₒᵤₜ is made zero. Thus, copper loss can be reduced the most and the motor efficiency can be improved the most.

Although the U-phase coil 2U, the V-phase coil 2V, and the W-phase coil 2W are arranged from the outer circumference side of the stator core 10 in this order as described above, the arrangement of these coils is not limited to this order as long as the coils 2U, 2V, and 2W are located at different positions in the radial direction.

In the second to fifth embodiments described below, a description will be given of specific configurations in which the resistance ratio Rₒᵤₜ/Rᵢₙ of the outer circumferential side coil to the inner circumferential side coil is made closer to the inductance ratio Lₒᵤₜ/Lᵢₙ for reducing copper loss.

### Second Embodiment

First, a second embodiment will be described. In the second embodiment, the resistance ratio Rₒᵤₜ/Rᵢₙ is made closer to the inductance ratio Lₒᵤₜ/Lᵢₙ to reduce copper loss, by setting circumferential lengths lᵢₙ and lₒᵤₜ of the outer side coil and the inner side coil.

In general, the resistance R of the coil 2 can be expressed by the following formula (8) using a circumferential length 1 of the coil 2, the diameter D and the resistivity p of each wire of the coil 2, and the number N of wires per turn of the coil 2.

$$\begin{matrix}[ Formula 8 ] & \\ R = ρ \frac{4 l}{π N {D}^{2}} & ( 8 )\end{matrix}$$

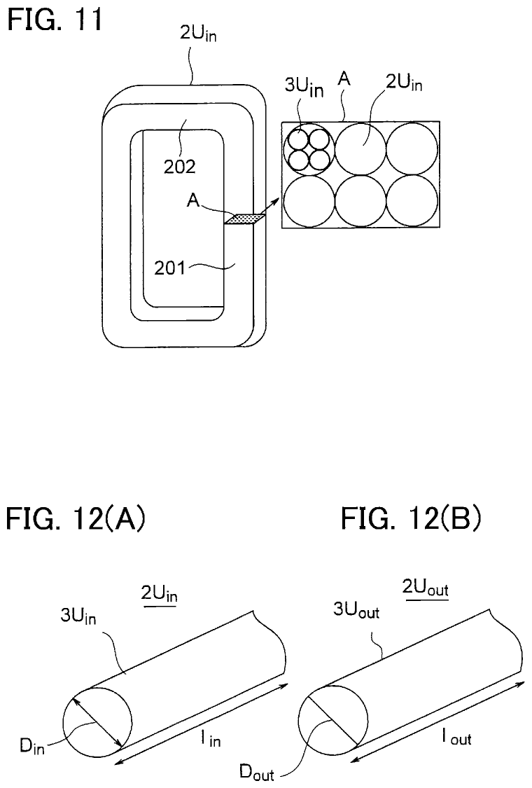

FIG. 11 is a schematic diagram illustrating one winding portion of the inner circumferential side coil 2Uᵢₙ (for example, the winding portion 21 illustrated in FIG. 4). In an example illustrated in FIG. 11, the inner circumferential side coil 2Uᵢₙ is wound with six turns per winding portion.

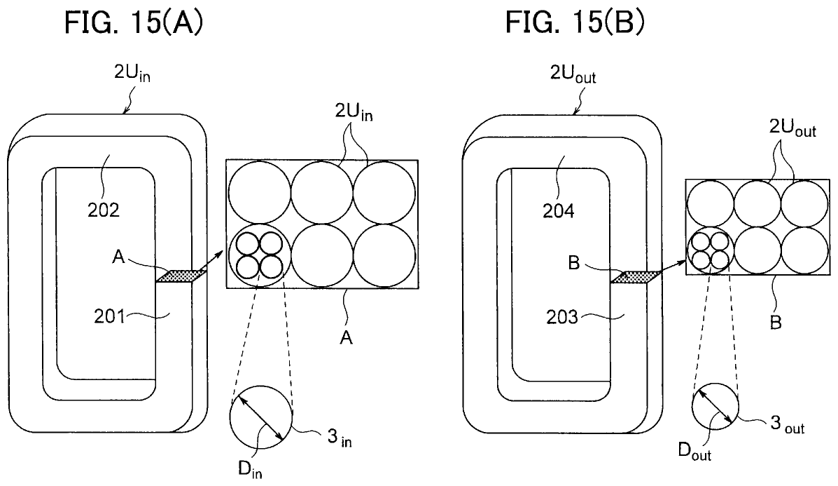

The inner circumferential side coil 2Uᵢₙ is formed of collective wires, i.e., a bundle of a plurality of wires 3Uᵢₙ Similarly, the outer circumferential side coil 2Uₒᵤₜ is formed of collective wires, i.e., a bundle of a plurality of wires 3Uₒᵤₜ (see FIG. 15(B)).

FIG. 12(A) is a schematic diagram illustrating the wire 3Uᵢₙ of the inner circumferential side coil 2Uᵢₙ. The wire 3Uᵢₙ is a conductor made of copper or aluminum covered with a not-shown coating. The diameter of the conductor is denoted by D and the resistivity thereof is denoted by ρᵢₙ.

FIG. 12(B) is a schematic diagram illustrating the wire 3Uₒᵤₜ of the outer circumferential side coil 2Uₒᵤₜ. The wire 3Uₒᵤₜ is a conductor made of copper or aluminum covered with a not-shown coating. The diameter of the conductor is denoted by Dₒᵤₜ, and the resistivity thereof is denoted by ρₒᵤₜ.

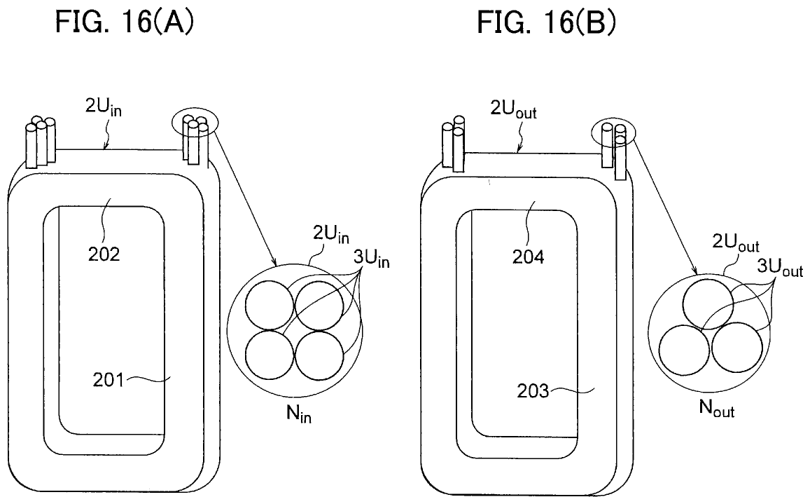

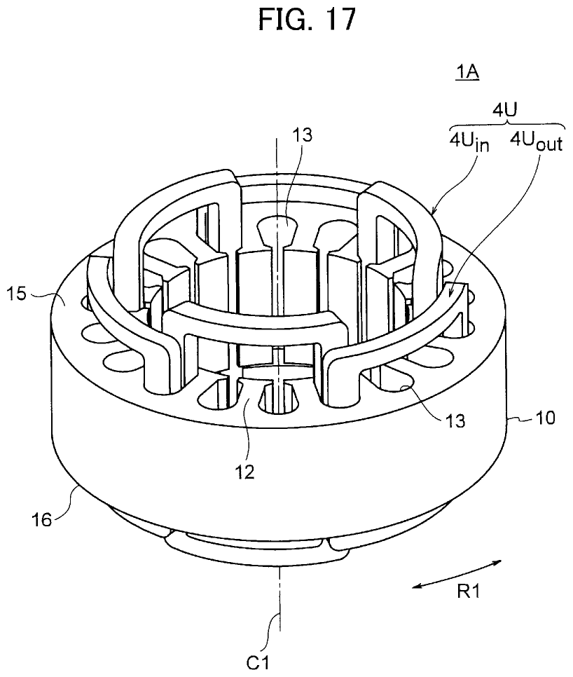

The number of wires 3Uᵢₙ per turn of the inner circumferential side coil 2Uᵢₙ is denoted by Nᵢₙ (see FIG. 16(A)). The number of wires 3Uₒᵤₜ per turn of the outer circumferential side coil 2Uₒᵤₜ is denoted by Nₒᵤₜ (see FIG. 16(B)).

Based on the formula (8), the resistance Rᵢₙ of the inner circumferential side coil 2Uᵢₙ and the resistance Rₒᵤₜ of the outer circumferential side coil 2Uₒᵤₜ can be expressed by the following formulas (9) and (10).

$$\begin{matrix}[ Formula 9 ] & \\ {R}_{in} = {ρ}_{in} \frac{4 {l}_{in}}{π {N}_{in} {D}_{in}^{2}} & ( 9 )\end{matrix}$$

$$\begin{matrix}[ Formula 10 ] & \\ {R}_{o u t} = {ρ}_{o u t} \frac{4 {l}_{o u t}}{π {N}_{o u t} {D}_{o u t}^{2}} & ( 10 )\end{matrix}$$

The following formula (11) is obtained by substituting the resistances Rᵢₙ and Rₒᵤₜ obtained by the formulas (9) and (10), into the formula (5) where the phase difference (ϕᵢₙ−ϕₒᵤₜ) is zero.

$$\begin{matrix}[ Formula 11 ] & \\ \begin{matrix}\frac{{L}_{o u t}}{{L}_{i n}} = \frac{{ρ}_{o u t} \frac{4 {l}_{o u t}}{π {N}_{o u t} {D}_{o u t}^{2}}}{{ρ}_{in} \frac{4 {l}_{i n}}{π {N}_{i n} {D}_{i n}^{2}}} \\ = \frac{{ρ}_{out} {l}_{out} {N}_{i n} {D}_{i n}^{2}}{{ρ}_{i n} {l}_{i n} {N}_{out} {D}_{out}^{2}}\end{matrix} & ( 11 )\end{matrix}$$

For the wires 3Uᵢₙ and 3Uₒᵤₜ of the coils 2Uᵢₙ and 2Uₒᵤₜ, when the diameters Dᵢₙ and Dₒᵤₜ are the same, the resistivities ρᵢₙ and ρₒᵤₜ are the same, and the numbers Nᵢₙ and Nₒᵤₜ per turn are the same, the resistance ratio Rₒᵤₜ/Rᵢₙ is equal to the circumferential length ratio lₒᵤₜ/lᵢₙ based on the formulas (9) and (10).

In the second embodiment, the circumferential length ratio lₒᵤₜ/lᵢₙ of the coils 2Uᵢₙ and 2Uₒᵤₜ is set according to the inductance ratio Lₒᵤₜ/Lᵢₙ, thus making the resistance ratio Rₒᵤₜ/Rᵢₙ (=Iₒᵤₜ/Iᵢₙ) closer to the inductance ratio Lₒᵤₜ/Lᵢₙ. This reduces the phase difference between the currents Iᵢₙ and Iₒᵤₜ to thereby reduce copper loss.

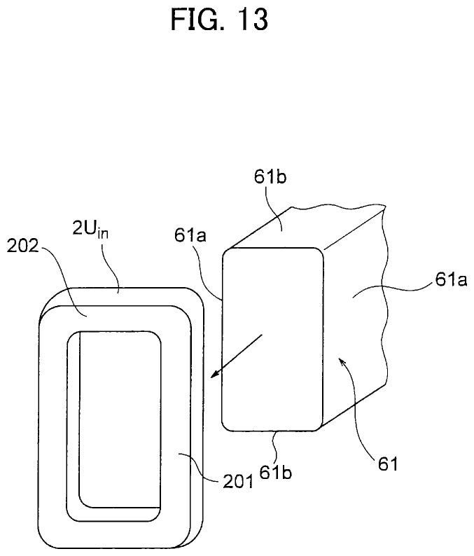

The circumferential lengths lᵢₙ and lₒᵤₜ of the coils 2Uᵢₙ and 2Uₒᵤₜ will be described. FIG. 13 is a schematic diagram illustrating a winding frame 61 for forming the winding portion of the inner circumferential side coil 2Uᵢₙ. The inner circumferential side coil 2Uᵢₙ is wound in a rectangular shape around the winding frame 61 having a rectangular cross-section, then detached from the winding frame 61 as indicated by the arrow, and attached to the stator core 10 using the inserter.

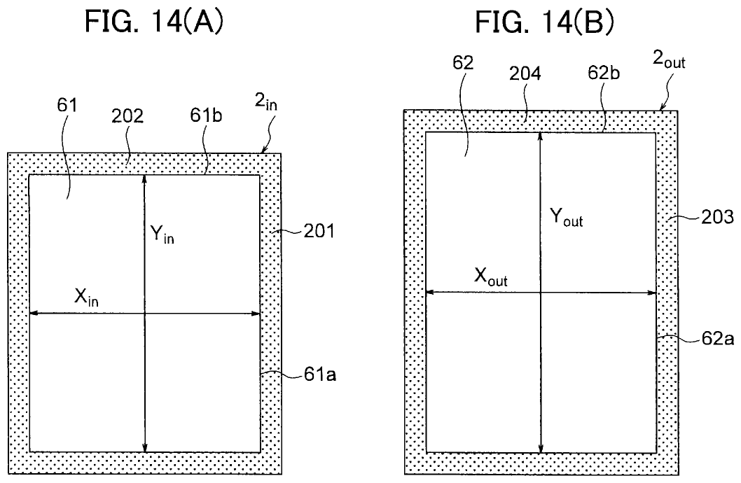

FIG. 14 (A) is a schematic diagram for explaining the circumferential length lᵢₙ of the inner circumferential side coil 2Uᵢₙ. The winding frame 61 for forming the winding portion of the inner circumferential side coil 2Uᵢₙ has two sides 61a facing the slot insertion portions 201 of the inner circumferential side coil 2Uᵢₙ and two sides 61b facing the coil ends 202 of the inner circumferential side coil 2Uᵢₙ.

The winding frame 61 has a width Xᵢₙ and a height Yᵢₙ. The width Xᵢₙ is the length of the side 61b, and the height Yᵢₙ is the length of the side 61a. The circumferential length lᵢₙ of the inner circumferential side coil 2Uᵢₙ is expressed as the product of (2×Xᵢₙ+2×Yᵢₙ) and the number of turns of the inner circumferential side coil 2Uᵢₙ.

FIG. 14 (B) is a schematic diagram for explaining the circumferential length lₒᵤₜ of the outer circumference side coil 2Uₒᵤₜ. The winding frame 62 for forming the winding portion of the outer circumferential side coil 2Uₒᵤₜ has two sides 62a facing the slot insertion portions 203 of the outer circumferential side coil 2Uₒᵤₜ and two sides 62b facing the coil ends 204 of the outer circumferential side coil 2Uₒᵤₜ.

The winding frame 62 has a width Xₒᵤₜ and a height Yₒᵤₜ. The width Xₒᵤₜ is the length of the side 62b, and the height Yₒᵤₜ is the length of the side 62a. The circumferential length lout of the outer circumferential side coil 2Uₒᵤₜ is expressed as the product of (2×Xₒᵤₜ+2×Yₒᵤₜ) and the number of turns of the outer circumferential side coil 2Uₒᵤₜ.

In the second embodiment, for the wires 3Uᵢₙ and 3Uₒᵤₜ of the coils 2Uᵢₙ and 2Uₒᵤₜ, the diameters Dᵢₙ and Dₒᵤₜ are the same, the resistivities ρᵢₙ and ρₒᵤₜ are the same, and the numbers Nᵢₙ and Nₒᵤₜ per turn are the same as described above. Thus, the resistance ratio Rₒᵤₜ/Rᵢₙ is equal to the circumferential length ratio lₒᵤₜ/lᵢₙ based on the formulas (9) and (10).

By making the circumferential length lᵢₙ of the inner circumferential side coil 2Uᵢₙ shorter than the circumferential length lₒᵤₜ of the outer circumferential side coil 2Uₒᵤₜ, the circumferential length ratio lₒᵤₜ/lᵢₙ is made greater than 1. Thus, the resistance ratio Rₒᵤₜ/Rᵢₙ (=lₒᵤₜ/lᵢₙ) can be made closer to the inductance ratio Lₒᵤₜ/Lᵢₙ. Consequently, the phase difference between the currents Iᵢₙ and Iₒᵤₜ can be reduced, and copper loss can be reduced.

Since the resistance ratio Rₒᵤₜ/Rᵢₙ is equal to the circumferential length ratio Lₒᵤₜ/Lᵢₙ, the formula (6) can be modified as the following formula (12).

$$\begin{matrix}[ Formula 12 ] & \\ 1.0 < \frac{{l}_{o u t}}{{l}_{i n}} < 1.217 \times \frac{{L}_{o u t}}{{L}_{i n}} & ( 12 )\end{matrix}$$

In addition, the formula (7) can be modified as the following formula (13).

$$\begin{matrix}[ Formula 13 ] & \\ 0.88 \times \frac{{L}_{o u t}}{{L}_{i n}} \leq \frac{{l}_{o u t}}{{l}_{i n}} \leq 1.15 \times \frac{{L}_{o u t}}{{L}_{i n}} & ( 13 )\end{matrix}$$

Furthermore, the formula (5) can be modified as the following formula (14).

$$\begin{matrix}[ Formula 14 ] & \\ \frac{{L}_{o u t}}{{L}_{i n}} = \frac{{l}_{o u t}}{{l}_{i n}} & ( 14 )\end{matrix}$$

That is, when the circumferential lengths lᵢₙ and lₒᵤₜ and the inductances Lᵢₙ and Lₒᵤₜ of the coils 2Uᵢₙ and 2Uₒᵤₜ satisfy the formula (12), copper loss is reduced and the motor efficiency is improved as compared to the motor satisfying Rᵢₙ=Rₒᵤₜ. In addition, when the formula (13) is satisfied, copper loss is further reduced, and the motor efficiency is further improved. Furthermore, when the formula (14) is satisfied, copper loss is reduced the most, and the motor efficiency is improved the most.

The U-phase coil 2U has been described herein, but the same can be applied to the V-phase coil 2V and the W-phase coil 2W.

As described above, in the second embodiment, the circumferential length lᵢₙ of the inner circumferential side coil is shorter than the circumferential length lₒᵤₜ of the outer circumferential side coil, and therefore lₒᵤₜ/lᵢₙ is greater than 1. Thus, the resistance ratio Rₒᵤₜ/Rᵢₙ can be made greater than 1 and made closer to the inductance ratio Lₒᵤₜ/Lᵢₙ. Consequently, copper loss due to non-uniform impedance can be reduced and the motor efficiency can be improved.

In the second embodiment, for the inner circumferential side coil and the outer circumferential side coil, the diameters Dᵢₙ and Dₒᵤₜ can be the same, the resistivities ρᵢₙ and ρₒᵤₜ can be the same, and the numbers Nᵢₙ and Nₒᵤₜ can be the same. Thus, the same kind of coils can be used for the inner circumferential side coil and the outer circumferential side coil, and therefore the manufacturing cost can be reduced.

### Third Embodiment

Next, a third embodiment will be described. In the third embodiment, the resistance ratio Rₒᵤₜ/Rᵢₙ is made closer to the inductance ratio Lₒᵤₜ/Lᵢₙ to reduce copper loss, by setting the diameters Dᵢₙ and Dₒᵤₜ of the wires 3Uᵢₙ and 3Uₒᵤₜ of the inner and outer circumferential side coils.

FIG. 15(A) is a schematic diagram for explaining the diameter Dᵢₙ of the wire 3Uᵢₙ of the inner circumferential side coil 2Uᵢₙ, and FIG. 15(B) is a schematic diagram for explaining the diameter Dₒᵤₜ of the wire 3Uₒᵤₜ of the outer circumferential side coil 2Uₒᵤₜ. As illustrated in FIGS. 15(A) and 15(B), the diameter Dᵢₙ of the wire 3Uᵢₙ is larger than the diameter Dₒᵤₜ of the wire 3Uₒᵤₜ (Dᵢₙ>Dₒᵤₜ).

In the third embodiment, for the coils 2Uᵢₙ and 2Uₒᵤₜ, the circumferential lengths lᵢₙ and lₒᵤₜ are the same, the resistivities ρᵢₙ and ρₒᵤₜ are the same, and the numbers Nᵢₙ and Nₒᵤₜ of wires 3Uᵢₙ and 3Uₒᵤₜ per turn are the same. Thus, based on the formulas (9) and (10), the resistance ratio Rₒᵤₜ/Rᵢₙ is equal to the wire diameter square ratio, i.e., Dᵢₙ²/Dₒᵤₜ².

As described above, the diameter Dᵢₙ of the wire 3Uᵢₙ of the inner circumferential side coil 2Uᵢₙ is larger than the diameter Dₒᵤₜ of the wire 3Uₒᵤₜ of the outer circumferential side coil 2Uₒᵤₜ, and therefore Dᵢₙ²/Dₒᵤₜ² is greater than 1. Thus, the resistance ratio Rₒᵤₜ/Rᵢₙ (=Dᵢₙ²/Dₒᵤₜ²) can be made greater than 1 and made closer to the inductance ratio Lₒᵤₜ/Lᵢₙ. Consequently, the phase difference between the currents Iᵢₙ and Iₒᵤₜ can be reduced, and copper loss due to non-uniform impedance can be reduced.

A conductor area of the wire 3Uᵢₙ of the inner circumferential side coil 2Uᵢₙ is expressed as (Dᵢₙ/2)²×π, while a conductor area of the wire 3Uₒᵤₜ of the outer circumferential side coil 2Uₒᵤₜ is expressed as (Dₒᵤₜ/2)²×π. Thus, in the third embodiment, it can be said that the cross-sectional area of the wire 3Uᵢₙ of the inner circumferential side coil 2Uᵢₙ is larger than the cross-sectional area of the wire 3Uₒᵤₜ of the outer circumferential side coil 2Uₒᵤₜ.

Since the resistance ratio Rₒᵤₜ/Rᵢₙ, is equal to the wire diameter square ratio Dᵢₙ²/Dₒᵤₜ², the formula (6) can be modified as the following formula (15).

$$\begin{matrix}[ Formula 15 ] & \\ 1.0 < \frac{{D}_{i n}^{2}}{{D}_{out}^{2}} < 1.217 \times \frac{{L}_{o u t}}{{L}_{i n}} & ( 15 )\end{matrix}$$

In addition, the formula (7) can be modified as the following formula (16).

$$\begin{matrix}[ Formula 16 ] & \\ 0.88 \times \frac{{L}_{o u t}}{{L}_{i n}} \leq \frac{{D}_{i n}^{2}}{{D}_{o u t}^{2}} \leq 1.15 \times \frac{{L}_{o u t}}{{L}_{i n}} & ( 16 )\end{matrix}$$

Furthermore, the formula (5) can be modified as the following formula (17).

$$\begin{matrix}[ Formula 17 ] & \\ \frac{{L}_{o u t}}{{L}_{i n}} = \frac{{D}_{i {n}^{2}}}{{D}_{o u {t}^{2}}} & ( 17 )\end{matrix}$$

That is, when the diameters Dᵢₙ and Dₒᵤₜ and the inductances Lᵢₙ and Lₒᵤₜ of the wires 3Uᵢₙ and 3Uₒᵤₜ of the coils 2Uᵢₙ and 2Uₒᵤₜ satisfy the formula (15), copper loss is reduced and the motor efficiency is improved as compared to the motor satisfying Rₒᵤₜ=Rᵢₙ. In addition, when the formula (16) is satisfied, copper loss is further reduced, and the motor efficiency is further improved. Furthermore, when the formula (17) is satisfied, copper loss is reduced the most, the motor efficiency is improved the most.

Although the U-phase coil 2U has been described herein, the same can be applied to the V-phase coil 2V and the W-phase coil 2W.

As described above, in the third embodiment, the diameter (wire diameter) Dᵢₙ of the wire of the inner circumferential side coil is larger than the diameter Dₒᵤₜ of the wire of the outer circumferential side coil, and therefore Dᵢₙ²/Dₒᵤₜ² is greater than 1. Thus, the resistance ratio Rₒᵤₜ/Rᵢₙ can be made greater than 1 and made closer to the inductance ratio Lₒᵤₜ/Lᵢₙ. Consequently, copper loss due to non-uniform impedance can be reduced and the motor efficiency can be improved.

### Fourth Embodiment

Next, a fourth embodiment will be described. In the fourth embodiment, the resistance ratio Rₒᵤₜ/Rᵢₙ is made closer to the inductance ratio Lₒᵤₜ/Lᵢₙ to reduce copper loss, by setting the numbers Nᵢₙ and Nₒᵤₜ of wires 3Uᵢₙ and 3Uₒᵤₜ of the inner circumferential side coil 2Uᵢₙ and the outer circumferential side coil 2Uₒᵤₜ.

FIG. 16 (A) is a schematic diagram for explaining the number Nᵢₙ of wires 3Uᵢₙ per turn of the inner circumferential side coil 2Uᵢₙ. FIG. 16 (B) is a schematic diagram for explaining the number Nₒᵤₜ of wires 3Uₒᵤₜ per turn of the outer circumferential side coil 2Uₒᵤₜ.

As illustrated in FIGS. 16(A) and 16(B), the number Nᵢₙ of wires 3Uᵢₙ per turn of the inner circumferential side coil 2Uᵢₙ is larger than the number Nₒᵤₜ of wires 3Uₒᵤₜ per turn of the outer circumferential side coil 2Uₒᵤₜ (Nᵢₙ>Nₒᵤₜ).

In the fourth embodiment, for the wires 3Uᵢₙ and 3Uₒᵤₜ of the coils 2Uᵢₙ and 2Uₒᵤₜ, the diameters Dᵢₙ and Dₒᵤₜ are the same, the resistivities ρᵢₙ and ρₒᵤₜ are the same, and the circumferential lengths lᵢₙ and lₒᵤₜ are the same. Thus, based on the formulas (9) and (10), the resistance ratio Rₒᵤₜ/Rᵢₙ is equal to the number ratio Nᵢₙ/Nₒᵤₜ.

As described above, the number Nᵢₙ of wires 3Uᵢₙ per turn of the inner circumferential side coil 2Uᵢₙ is larger than the number Nₒᵤₜ of wires 3Uₒᵤₜ per turn of the outer circumferential side coil 2Uₒᵤₜ, and therefore Nᵢₙ/Nₒᵤₜ is greater than 1. Thus, Rₒᵤₜ/Rᵢₙ (=Nᵢₙ/Nₒᵤₜ) can be made greater than 1 and made closer to the inductance ratio Lₒᵤₜ/Lᵢₙ. Consequently, the phase difference between the currents Iᵢₙ and Iₒᵤₜ can be reduced, and thus copper loss due to non-uniform impedance can be reduced.

Since the resistance ratio Rₒᵤₜ/Rᵢₙ is equal to the number ratio Nᵢₙ/Nₒᵤₜ, the formula (6) can be modified as the following formula (18).

$$\begin{matrix}[ Formula 18 ] & \\ 1.0 < \frac{{N}_{o u t}}{{N}_{i n}} < 1.217 \times \frac{{L}_{o u t}}{{L}_{i n}} & ( 18 )\end{matrix}$$

In addition, the formula (7) can be modified as the following formula (19).

$$\begin{matrix}[ Formula 19 ] & \\ 0.88 \times \frac{{L}_{o u t}}{{L}_{i n}} \leq \frac{{N}_{o u t}}{{N}_{i n}} \leq 1.15 \times \frac{{L}_{o u t}}{{L}_{i n}} & ( 19 )\end{matrix}$$

Furthermore, the formula (5) can be modified as the following formula (20).

$$\begin{matrix}[ Formula 20 ] & \\ \frac{{L}_{o u t}}{{L}_{i n}} = \frac{{N}_{o u t}}{{N}_{i n}} & ( 20 )\end{matrix}$$

That is, when the numbers Nᵢₙ and Nₒᵤₜ of wires 3Uᵢₙ and 3Uₒᵤₜ per turn and the inductances Lᵢₙ and Lₒᵤₜ of the coils 2Uᵢₙ and 2Uₒᵤₜ satisfy the formula (18), copper loss is reduced and the motor efficiency is improved as compared to the motor satisfying Rᵢₙ=Rₒᵤₜ. In addition, when the formula (19) is satisfied, copper loss is further reduced, and the motor efficiency is further improved. Furthermore, when the formula (20) is satisfied, copper loss is reduced the most, and the motor efficiency is improved the most.

Although the U-phase coil 2U has been described herein, the same can be applied to the V-phase coil 2V and the W-phase coil 2W.

As described above, in the fourth embodiment, the number Nᵢₙ of wires 3Uᵢₙ per turn of the inner circumferential side coil 2Uᵢₙ is larger than the number Nₒᵤₜ of wires 3Uₒᵤₜ per turn of the outer circumferential side coil 2Uₒᵤₜ, and therefore Nᵢₙ/Nₒᵤₜ is greater than 1. Thus, the resistance ratio Rₒᵤₜ/Rᵢₙ can be made greater than 1 and made closer to the inductance ratio Lₒᵤₜ/Lᵢₙ. Consequently, copper loss due to non-uniform impedance can be reduced to improve the motor efficiency.

### Fifth Embodiment

Next, a fifth embodiment will be described. In the fifth embodiment, the resistance ratio Rₒᵤₜ/Rᵢₙ is made closer to the inductance ratio Lₒᵤₜ/Lᵢₙ to reduce copper loss, by setting the resistivities ρᵢₙ and ρₒᵤₜ of the wires of an inner circumferential side coil 4Uᵢₙ and an outer circumferential side coil 4Uₒᵤₜ.

FIG. 17 is a perspective view illustrating the stator core 10 and a U-phase coil 4U of the fifth embodiment. In the fifth embodiment, the material of a wire forming an inner circumferential side coil 4Uᵢₙ of the U-phase coil 4U is different from the material of a wire forming an outer circumferential side coil 4Uₒᵤₜ, and therefore the resistivities ρᵢₙ and ρₒᵤₜ are different from each other.

In the fifth embodiment, the wire of the inner circumferential side coil 4Uᵢₙ is composed of a copper wire, while the wire of the outer circumferential side coil 4Uₒᵤₜ is composed of an aluminum wire. Thus, the resistivity ρᵢₙ of the wire of the inner circumferential side coil 4Uᵢₙ is smaller than the resistivity ρₒᵤₜ of the wire of the outer circumferential side coil 4Uₒᵤₜ (ρᵢₙ<ρₒᵤₜ).

In the fifth embodiment, for the coils 4Uᵢₙ and 4Uₒᵤₜ, the circumferential lengths lᵢₙ and lₒᵤₜ are the same, the diameters Dᵢₙ and Dₒᵤₜ are the same, and the numbers Nᵢₙ and Nₒᵤₜ of wires per turn are the same. Thus, based on the formulas (9) and (10), the resistance ratio Rₒᵤₜ/Rᵢₙ is equal to the resistivity ratio ρₒᵤₜ/ρᵢₙ.

As described above, the resistivity ρᵢₙ of the wire of the inner circumferential side coil 4Uᵢₙ is smaller than the resistivity ρₒᵤₜ of the wire of the outer circumferential side coil 4Uₒᵤₜ, and therefore ρₒᵤₜ/ρᵢₙ is greater than 1. Thus, the resistance ratio Rₒᵤₜ/Rᵢₙ (=ρₒᵤₜ/ρᵢₙ) can be made greater than 1 and made closer to the inductance ratio Lₒᵤₜ/Lᵢₙ. Consequently, the phase difference between the currents Iᵢₙ and Iₒᵤₜ can be reduced, and thus copper loss due to non-uniform impedance can be reduced.

Since the resistance ratio Rₒᵤₜ/Rᵢₙ is equal to the resistivity ratio ρₒᵤₜ/ρᵢₙ, in the formula (6) can be modified as the following formula (21).

$$\begin{matrix}[ Formula 21 ] & \\ 1.0 < \frac{{ρ}_{o u t}}{{ρ}_{i n}} < 1.217 \times \frac{{L}_{o u t}}{{L}_{i n}} & ( 21 )\end{matrix}$$

In addition, the formula (7) can be modified as the following formula (22).

$$\begin{matrix}[ Formula 22 ] & \\ 0.88 \times \frac{{L}_{o u t}}{{L}_{i n}} \leq \frac{{ρ}_{o u t}}{{ρ}_{i n}} \leq 1.15 \times \frac{{L}_{o u t}}{{L}_{i n}} & ( 22 )\end{matrix}$$

Furthermore, the formula (5) can be modified as the following formula (23).

$$\begin{matrix}[ Formula 23 ] & \\ \frac{{L}_{o u t}}{{L}_{i n}} = \frac{{ρ}_{o u t}}{{ρ}_{i n}} & ( 23 )\end{matrix}$$

That is, when the resistivities ρᵢₙ and ρₒᵤₜ and the inductances Lᵢₙ and Lₒᵤₜ of the wires of the coils 4Uᵢₙ and 4Uₒᵤₜ satisfy the formula (21), copper loss in the motor is reduced and the motor efficiency is improved as compared to the motor satisfying Rₒᵤₜ=Rᵢₙ. In addition, when the formula (22) is satisfied, copper loss is further reduced, and the motor efficiency is further improved. Furthermore, when the formula (23) is satisfied, copper loss is reduced the most, and the motor efficiency is improved the most.

Although the U-phase coil 4U has been described herein, the same can be applied to the V-phase coil and the W-phase coil. The wires of the inner and outer circumferential side coils are not limited to a combination of aluminum and copper wires as long as the resistivity of the wire of the inner circumferential side coil is smaller than the resistivity of the wire of the outer circumferential side coil.

As described above, in the fifth embodiment, the resistivity ρᵢₙ of the wire of the inner circumferential side coil is smaller than the resistivity ρₒᵤₜ of the wire of the outer circumferential side coil, and therefore ρₒᵤₜ/ρᵢₙ is greater than 1. Thus, the resistance ratio Rₒᵤₜ/Rᵢₙ can be made greater than 1 and made closer to the inductance ratio Lₒᵤₜ/Lᵢₙ. Consequently, copper loss due to non-uniform impedance can be reduced and the motor efficiency can be improved.

The second to fifth embodiments can be combined as appropriate so that the resistance Rᵢₙ of the inner circumferential side coil is smaller than the resistance Rₒᵤₜ of the outer circumferential side coil.

### Compressor

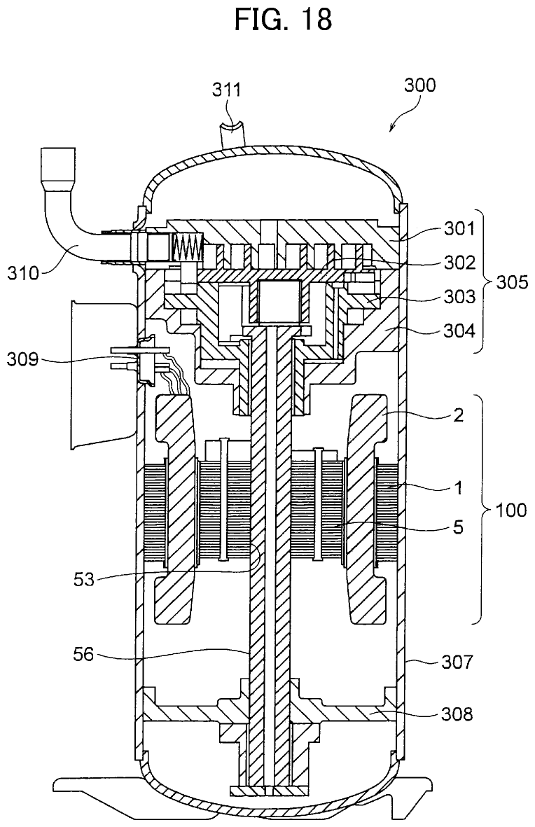

Next, a compressor 300 to which the motor described in each embodiment is applicable will be described. FIG. 18 is a cross-sectional view illustrating the compressor 300. The compressor 300 is a scroll compressor in this example, but is not limited thereto. The compressor 300 includes a sealed container 307, a compression mechanism 305 disposed in the sealed container 307, the motor 100 that drives the compression mechanism 305, the shaft 56 connecting the compression mechanism 305 and the motor 100, and a subframe 308 that supports a lower end of the shaft 56.

The compression mechanism 305 includes a fixed scroll 301 having a spiral portion, an orbiting scroll 302 having a spiral portion that forms a compression chamber between the spiral portions of the fixed scroll 301 and the orbiting scroll 302, a compliance frame 303 that holds an upper end of the shaft 56, and a guide frame 304 that is fixed to the sealed container 307 and holds the compliance frame 303.

A suction pipe 310 that penetrates the sealed container 307 is press-fitted into the fixed scroll 301. The sealed container 307 is provided with a discharge pipe 311 for discharging a high-pressure refrigerant gas discharged from the fixed scroll 301 to the outside. The discharge pipe 311 communicates with a not-shown opening that is provided between the compression mechanism 305 and the motor 100 in the sealed container 307.

The motor 100 is fixed to the sealed container 307 by fitting the stator 1 into the sealed container 307. The configuration of the motor 100 has been described above. Glass terminals 309 for supplying electric power to the motor 100 are fixed to the sealed container 307 by welding.

When the motor 100 rotates, its rotation is transmitted to the orbiting scroll 302, causing the orbiting scroll 302 to orbit. As the orbiting scroll 302 orbits, the volume of the compression chamber formed by the spiral portion of the orbiting scroll 302 and the spiral portion of the fixed scroll 301 changes. Then, a refrigerant gas is sucked in through the suction pipe 310, compressed, and discharged through the discharge pipe 311.

The motor described in each embodiment is applicable to the motor 100 of the compressor 300 and thus the motor 100 has high motor efficiency. Thus, the operating efficiency of the compressor 300 can be improved.

### Air Conditioner

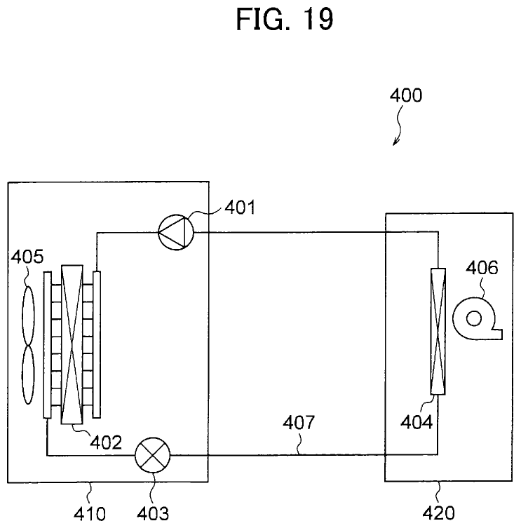

Next, an air conditioner 400 to which the motor described in each embodiment is applicable will be described. FIG. 19 is a diagram illustrating the air conditioner 400 (refrigeration cycle device). The air conditioner 400 includes a compressor 401, a condenser 402, a throttle device (decompression device) 403, and an evaporator 404. The compressor 401, the condenser 402, the throttle device 403, and the evaporator 404 are coupled together by a refrigerant pipe 407 to constitute a refrigeration cycle. That is, the refrigerant circulates through the compressor 401, the condenser 402, the throttle device 403, and the evaporator 404 in this order.

The compressor 401, the condenser 402, and the throttle device 403 are provided in an outdoor unit 410. The compressor 401 is formed of the compressor 300 illustrated in FIG. 18. The outdoor unit 410 is provided with an outdoor fan 405 that supplies outdoor air to the condenser 402. The evaporator 404 is provided in an indoor unit 420. The indoor unit 420 is provided with an indoor fan 406 that supplies indoor air to the evaporator 404.

The operation of the air conditioner 400 is as follows. The compressor 401 compresses the sucked refrigerant and sends out the compressed refrigerant. The condenser 402 exchanges heat between the refrigerant flowing in from the compressor 401 and outdoor air to condense and liquefy the refrigerant, and sends out the liquefied refrigerant to the refrigerant pipe 407. The outdoor fan 405 supplies outdoor air to the condenser 402. The throttle device 403 adjusts the pressure of refrigerant flowing through the refrigerant pipe 407.

The evaporator 404 exchanges heat between the refrigerant brought into a low-pressure state by the throttle device 403 and indoor air to cause the refrigerant to remove heat from the air, thereby evaporating (vaporizing) the refrigerant, and then sends out the evaporated refrigerant to the refrigerant pipe 407. The indoor fan 406 supplies indoor air to the evaporator 404. Thus, cooled air from which the heat is removed in the evaporator 404 is supplied to the interior of a room.

The motor described in each embodiment is applicable to the motor 100 of the compressor 401 (or the compressor 300), and thus the motor 100 has high motor efficiency. Thus, the operating efficiency of the compressor 401 is improved, and therefore it is possible to improve the operating efficiency of the air conditioner 400.

Although the desirable embodiments of the present disclosure have been specifically described above, the present disclosure is not limited to the above-described embodiments, and various modifications or changes can be made to those embodiments without departing from the scope of the present disclosure.

1. A stator comprising:
a stator core having an inner circumference and an outer circumference each of which is annular, and a slot which opens to the inner circumference; and
a coil wound on the stator core in distributed winding,
wherein the coil has an inner circumferential side coil disposed on an inner circumference side in the slot and an outer circumferential side coil disposed on an outer circumference side in the slot, the inner circumferential side coil and the outer circumferential side coil being of the same phase and connected in parallel, and
wherein a resistance of the inner circumferential side coil is smaller than a resistance of the outer circumferential side coil.

2. The stator according to claim 1, wherein an inductance Lₒᵤₜ and a resistance Rₒᵤₜ of the outer circumferential side coil and an inductance Lᵢₙ and a resistance Rᵢₙ of the inner circumferential side coil satisfy the following formula.
$$1.0 < \frac{{R}_{out}}{{R}_{i n}} < 1.217 \times \frac{{L}_{out}}{{L}_{i n}}$$

3. The stator according to claim 1, wherein an inductance Lₒᵤₜ and a resistance Rₒᵤₜ of the outer circumferential side coil and an inductance Lᵢₙ and a resistance Rᵢₙ of the inner circumferential side coil satisfy the following formula.
$$0.88 \times \frac{{L}_{out}}{{L}_{i n}} \leq \frac{{R}_{out}}{{R}_{i n}} \leq 1.15 \times \frac{{L}_{out}}{{L}_{i n}}$$

4. The stator according to claim 1, wherein an inductance Lₒᵤₜ and a resistance Rₒᵤₜ of the outer circumferential side coil and an inductance Lᵢₙ and a resistance Rᵢₙ of the inner circumferential side coil satisfy the following formula.
$$\frac{{L}_{o u t}}{{L}_{i n}} = \frac{{R}_{o u t}}{{R}_{i n}}$$

5. The stator according to claim 1, wherein a circumferential length of the inner circumferential side coil is shorter than a circumferential length of the outer circumferential side coil.

6. The stator according to claim 1, wherein a cross-sectional area of a wire of the inner circumferential side coil is larger than a cross-sectional area of a wire of the outer circumferential side coil.

7. The stator according to claim 1, wherein a wire diameter of a wire of the inner circumferential side coil is larger than a wire diameter of a wire of the outer circumferential side coil.

8. The stator according to claim 1, wherein the number of wires per turn of the inner circumferential side coil is larger than the number of wires per turn of the outer circumferential side coil.

9. The stator according to claim 1, wherein a resistivity of a wire of the inner circumferential side coil is smaller than a resistivity of a wire of the outer circumferential side coil.

10. The stator according to claim 9, wherein the wire of the inner circumferential side coil is a copper wire.

11. The stator according to claim 9, wherein the wire of the outer circumferential side coil is an aluminum wire.

12. The stator according to claim 1,
wherein the coil has a first-phase coil, a second-phase coil, and a third-phase coil, and
wherein each of the first-phase coil, the second-phase coil, and the third-phase coil has the inner circumferential side coil and the outer circumferential side coil.

13. A motor comprising:
the stator according to claim 1; and
a rotor rotatably provided inside the stator.

14. A compressor:
the motor according to claim 13; and
a compression mechanism to be driven by the motor.

15. An air conditioner comprising the compressor according to claim 14, a condenser, a decompression device, and an evaporator.
